(19) United States
(12) Patent Application Publication
(10) Pub. No.: US 2019/0164309 A1
(43) Pub. Date: May 30, 2019

(54) METHOD OF DETECTING SHOOTING DIRECTION AND APPARATUSES PERFORMING THE SAME

(71) Applicant: Electronics and Telecommunications Research Institute, Daejeon (KR)

(72) Inventors: SungWon BYON, Gwangju-si Gyeonggi-do (KR); Eun Jung KWON, Daejeon (KR); Hyunho PARK, Daejeon (KR); Yong Tae LEE, Daejeon (KR); Won Jae LEE, Sejong-si (KR); Dong Man JANG, Sejong-si (KR); Eui Suk JUNG, Daejeon (KR); Sun-Joong KIM, Sejong-si (KR)

(73) Assignee: Electronics and Telecommunications Research Institute, Daejeon (KR)

(21) Appl. No.: 16/170,673

(22) Filed: Oct. 25, 2018

(30) Foreign Application Priority Data
Nov. 29, 2017 (KR) 10-2017-0161675
Jan. 31, 2018 (KR) 10-2018-0012386

(51) Int. Cl. G06T 7/73; G06K 9/00; G06K 9/46

(52) U.S. Cl. CPC G06T 7/74; G06T 2207/30244; G06K 9/4638; G06K 9/00771

(57) ABSTRACT

Disclosed is a method of detecting a shooting direction and apparatuses performing the method, the method including calculating a crossed angle between an object and a shadow of the object in an image and detecting a shooting direction of a shooting apparatus used for capturing the image based on the crossed angle and a reference angle corresponding to a time and a position at which the image is captured.

### CROSS-REFERENCE TO RELATED APPLICATION(S)

This application claims the priority benefit of Korean Patent Application No. 10-2017-0161675 filed on Nov. 29, 2017 and Korean Patent Application No. 10-2018-0012386 filed on Jan. 31, 2018 in the Korean Intellectual Property Office, the disclosures of which are incorporated herein by reference for all purposes.

### BACKGROUND

### 1. Field

One or more example embodiments relate to a method of detecting a shooting direction and apparatuses performing the method.

### 2. Description of Related Art

Image analysis techniques are introduced through many papers and demonstrations and a perfectivity thereof are increasing with the development of machine learning technology.

An application range of CCTV images is expanding due to the image analysis technology. The CCTV images may be used in various ways to perform, for example, object recognition, context recognition, and intelligent retrieval as well as simple storage and playback functions.

The image analysis technology may extract objects captured in an image by analyzing a CCTV image, and classify the objects for each type based on characteristics or determine whether the objects are the same object. A CCTV installation position and installation direction, that is, a shooting direction of a CCTV in which an image is captured may increase an accuracy and an efficiency of an image analysis.

When it is possible to previously determine a direction of an object to be recognized in the CCTV based on the CCTV installation position and the shooting direction, the image analysis technology may determine whether a front view or a rear view of the object is captured in the CCTV based on the shooting direction of the CCTV.

As such, in the image analysis technology, the CCTV installation position and the shooting direction may be used to detect the object with increased efficiency.

### SUMMARY

An aspect provides technology for detecting a shooting direction of a shooting apparatus used for capturing an image using the image.

Another aspect also provides technology for improving an accuracy of an object recognition by applying a shooting direction.

According to an aspect, there is provided a method of detecting a shooting direction, the method including calculating a crossed angle between an object and a shadow of the object in an image and detecting a shooting direction of a shooting apparatus used for capturing the image based on the crossed angle and a reference angle corresponding to a time and a position at which the image is captured.

The crossed angle may be a crossed angle between a vertical component of the object and a shadow formed by the vertical component.

The position may be one of an installation position of the shooting apparatus and an approximate position of the installation position.

The time may be a time and a date at which the image including the object is captured.

The calculating may include extracting, from the image, a vertical component of the object and a shadow formed by the vertical component and extracting a first representative segment that represents the vertical component and a second representative segment that represents the shadow and calculating a crossed angle between the first representative segment and the second representative segment.

The method may further include acquiring the reference angle based on the time and the position at which the image is captured.

The acquiring may include determining a crossed angle corresponding to the time and the position at which the image is captured to be the reference angle from stored crossed angles.

The stored crossed angles may include crossed angles between a predetermined object and a shadow of the predetermined object calculated based on azimuth and meridian altitude of a sun for each time and for each position.

The determining may include calculating, through an interpolation, a crossed angle approximate to the time and the position at which the image is captured among the stored crossed angles and determining the calculated crossed angle to be the reference angle.

The detecting may include calculating an angle of difference between the crossed angle and the reference angle and detecting the shooting direction of the shooting apparatus by analyzing the angle of difference based on a reference direction corresponding to the reference angle.

The method may further include storing the shooting direction of the shooting apparatus by matching the shooting direction with an identifier of the shooting apparatus.

The identifier may be an identification (ID) that represents the shooting apparatus such that the shooting apparatus is able to be identified.

According to another aspect, there is also provided a shooting direction detecting apparatus including a collector configured to acquire an image from a shooting apparatus used for capturing the image and a shooting direction analyzer configured to calculate a crossed angle between an object and a shadow of the object in the image and detect a shooting direction of the shooting apparatus used for capturing the image based on the crossed angle and a reference angle corresponding to a time and a position at which the image is captured.

The crossed angle may be a crossed angle between a vertical component of the object and a shadow formed by the vertical component.

The position may be one of an installation position of the shooting apparatus and an approximate position of the installation position.

The time may be a time and a date at which the image including the object is captured.

The shooting direction analyzer may be configured to extract, from the image, a vertical component of the object and a shadow formed by the vertical component, extract a first representative segment that represents the vertical component and a second representative segment that represents the shadow, and calculate a crossed angle between the first representative segment and the second representative segment.

The shooting direction analyzer may include a reference angle calculator configured to acquire the reference angle based on the time and the position at which the image is captured.

The reference angle calculator may be configured to determine a crossed angle corresponding to the time and the position at which the image is captured to be the reference angle from stored crossed angles.

The stored crossed angles may include crossed angles between a predetermined object and a shadow of the predetermined object calculated based on azimuth and meridian altitude of a sun for each time and for each position.

The reference angle calculator may be configured to calculate, through an interpolation, a crossed angle approximate to the time and the position at which the image is captured among the stored crossed angles and determine the calculated crossed angle to be the reference angle.

The shooting direction analyzer may include a shooting direction calculator configured to calculate an angle of difference between the crossed angle and the reference angle and detect the shooting direction of the shooting apparatus by analyzing the angle of difference based on a reference direction corresponding to the reference angle.

The shooting direction analyzer may include a shooting direction manager configured to store the shooting direction of the shooting apparatus by matching the shooting direction with an identifier of the shooting apparatus.

The identifier may be an ID that represents the shooting apparatus such that the shooting apparatus is able to be identified.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a shooting direction detecting system according to an example embodiment;

FIG. 2 is a diagram illustrating an example of the shooting direction detecting system of FIG. 1;

FIG. 3 is a diagram illustrating a crossed angle according to an example embodiment;

FIG. 4 is a block diagram illustrating a shooting direction analyzer of FIG. 2;

FIG. 5 is a flowchart illustrating an operation of a shooting direction detecting apparatus of FIG. 1; and

FIG. 6 is a diagram illustrating a method of detecting a shooting direction using a reference angle and a crossed angle according to an example embodiment.

### DETAILED DESCRIPTION

Hereinafter, example embodiments will be described in detail with reference to the accompanying drawings. It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular embodiments only and is not intended to be limiting. As used herein, the singular forms “a.” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

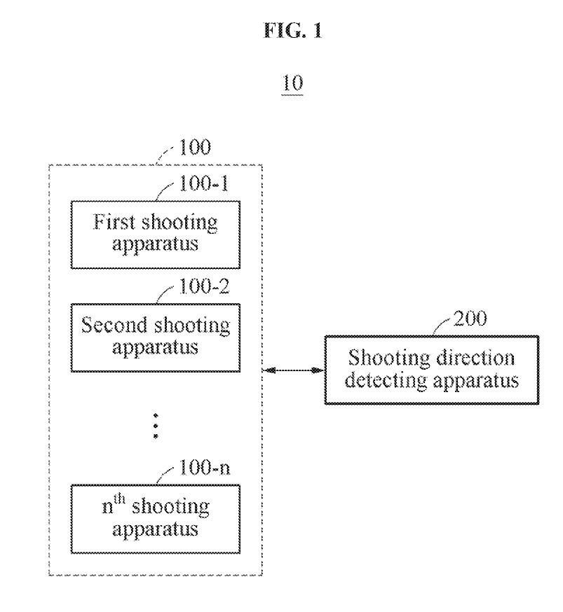

FIG. 1 is a block diagram illustrating a shooting direction detecting system according to an example embodiment.

Referring to FIG. 1, a shooting direction detecting system 10 may include a shooting apparatus 100 and a shooting direction detecting apparatus 200.

The shooting apparatus 100 may include a plurality of shooting apparatuses. For example, the plurality of shooting apparatuses may be a first shooting apparatus 100-1 through an n^{th} shooting apparatus 100-n installed outdoors and/or indoors.

The shooting apparatus 100 may be an apparatus for capturing an object and generating an image. The shooting apparatus 100 may be, for example, a camera and a closed-circuit television (CCTV). As described above, the shooting apparatus 100 may be the camera and the CCTV, but is not limited thereto. The shooting apparatus 100 may be various devices for generating an image.

The shooting apparatus 100 may transmit an image to the shooting direction detecting apparatus 200. The shooting apparatus 100 may transmit an image including an object to the shooting direction detecting apparatus 200.

The shooting direction detecting apparatus 200 may detect a shooting direction in which the shooting apparatus 100 captures the image based on a reference angle and a crossed angle between the object included in the image and a shadow of the object.

Based on the detected shooting direction, the shooting direction detecting apparatus 200 may selectively search for an image of a shooting apparatus having a shooting direction coincident with a moving direction of the object among the shooting apparatus 100. The image found by the searching may be used for object recognition, so that an accuracy of the object recognition is improved.

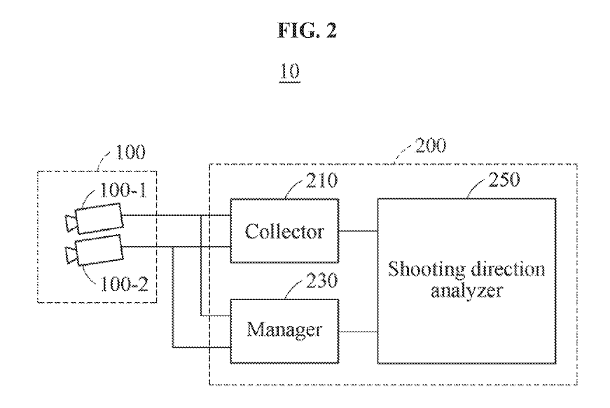

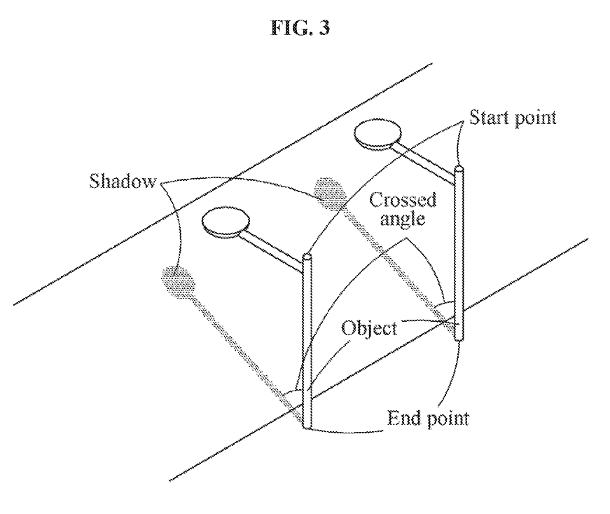

FIG. 2 is a diagram illustrating an example of the shooting direction detecting system 10 of FIG. 1 and FIG. 3 is a diagram illustrating a crossed angle according to an example embodiment.

Referring to FIGS. 2 and 3, the shooting apparatus 100 may include the first shooting apparatus 100-1 and a second shooting apparatus 100-2.

Each of the first shooting apparatus 100-1 and the second shooting apparatus 100-2 may capture an object and generate an image as illustrated in FIG. 3.

Each of the first shooting apparatus 100-1 and the second shooting apparatus 100-2 may transmit the image including the object and a shadow of the object to the shooting direction detecting apparatus 200.

The shooting direction detecting apparatus 200 may include a collector 210, a manager 230, and a shooting direction analyzer 250.

The shooting direction detecting apparatus 200 may detect a shooting direction of the shooting apparatus 100 using the image, store the shooting direction of the shooting apparatus 100, and provide information associated with the shooting apparatus 100.

The collector 210 may acquire the image from the shooting apparatus 100.

The collector 210 may also acquire the information associated with the shooting apparatus 100. The information associated with the shooting apparatus 100 may include at least one of a time and a position at which the shooting apparatus 100 captures the image, and an identifier for identifying the shooting apparatus 100. The position may be one of an installation position of the shooting apparatus 100 and an approximate position of the installation position. The time may be a time and a date at which the shooting apparatus 100 captures the image including the object. The identifier may be an identification (ID) that represents the shooting apparatus 100.

The collector 210 may transmit the image to the shooting direction analyzer 250. The collector 210 may transmit the information associated with the shooting apparatus 100 to the shooting direction analyzer 250. Also, the collector 210 may store the information associated with the shooting apparatus 100 in a database (not shown).

The manager 230 may manage the installation position of the shooting apparatus 100. In one example, the manager 230 may match the installation position of the shooting apparatus 100 to the identifier of the shooting apparatus 100 and store the installation position of the shooting apparatus 100 using a latitude and a longitude of the installation position in the database (not shown). In another example, the manager 230 may manage the installation position of the shooting apparatus 100 in a variety of forms such as an address and a region code.

Although FIG. 2 illustrates that the collector 210 and the manager 230 are included in the shooting direction detecting apparatus 200, embodiments are not limited thereto. Depending on an example, the collector 210 and the manager 230 may be separately provided and implemented outside the shooting direction detecting apparatus 200.

The shooting direction analyzer 250 may detect, store, and provide the shooting direction of the shooting apparatus 100 in conjunction with the collector 210 and the manager 230.

The shooting direction analyzer 250 may detect the shooting direction of the shooting apparatus 100 using a reference angle and a crossed angle between the object and the shadow of the object included in the image. The reference angle may refer to an angle, for example, a crossed angle, corresponding to a time and a position at which an image is captured.

The shooting direction analyzer 250 may calculate the crossed angle between the object and the shadow of the object in the image.

Referring to FIG. 3, in the image, the object may be an object including a vertical component. The object may be a vertically grounded object such as a street tree, a telephone pole, a wall of a building, a column of a street lamp, and a column of a traffic light. The shadow of the object may be a shadow formed by the vertical component of the object. The shadow of the object may be connected with the object. For example, the shadow of the object may be connected to an end point of the object in contact with the ground as illustrated in FIG. 3. The crossed angle may be a crossed angle between the vertical component of the object, for example, the street lamp of FIG. 3, and the shadow formed by the vertical component.

A direction of a shadow of a real object may be determined based on azimuth and meridian altitude of a sun. In the image, a direction of the shadow of the object may be determined based on the shooting direction of the shooting apparatus 100. Thus, to detect the shooting direction of the shooting apparatus 100, the shooting direction analyzer 250 may use the crossed angle between the object and the shadow of the object in the image.

Thereafter, the shooting direction analyzer 250 may acquire the reference angle corresponding to the time and the position at which the image is captured. The reference angle may refer to a crossed angle between a predetermined object and a shadow of the object acquired in a direction determined for each position and for each time, for example, in the due south direction, the due north direction, and a known shooting direction.

The shooting direction analyzer 250 may detect the shooting direction of the shooting apparatus 100 by comparing the crossed angle between the object and the shadow of the object in the image acquired from the shooting apparatus 100 to the reference angle corresponding to the time and the position at which the image is captured among reference angles acquired in the determined direction.

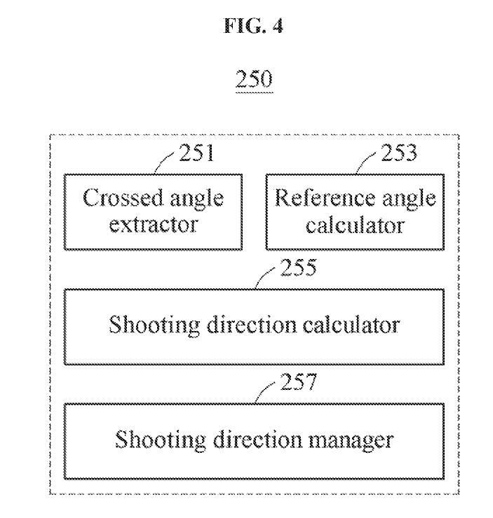

Hereinafter, the shooting direction analyzer 250 will be further described with reference to FIG. 4.

FIG. 4 is a block diagram illustrating the shooting direction analyzer 250 of FIG. 2

Referring to FIG. 4, the shooting direction analyzer 250 may include a crossed angle extractor 251, a reference angle calculator 253, a shooting direction calculator 255, and a shooting direction manager 257.

The crossed angle extractor 251 may extract an object and a shadow of the object from an image and calculate a crossed angle between the object and the shadow of the object, which may be a first element for detect a shooting direction of the shooting apparatus 100.

The crossed angle extractor 251 may analyze the image and extract a vertical component of the object and a shadow formed by the vertical component from the image. For example, the crossed angle extractor 251 may extract the object and the shadow of the object by identifying a connection between the shadow formed by the vertical component and an end point of the vertical component of the object as illustrated in FIG. 3.

The crossed angle extractor 251 may extract a first representative segment that represents the vertical component of the object and a second representative segment that represents the shadow, and calculate a crossed angle between the first representative segment and the second representative segment.

For example, the crossed angle extractor 251 may extract coordinates of a start point and an end point of the vertical component of the object based on coordinates on the image. The start point of the vertical component may be a point that is the farthest from the ground. The end point of the vertical component may be a point that is the closest to the ground. The end point may be directly in contact with the ground. The crossed angle extractor 251 may calculate the first representative segment using a linear function using the coordinates of the start point and the end point of the vertical component of the object. The linear function may be a function of x and y coordinates based on the coordinates on the image.

The crossed angle extractor 251 may extract coordinates of a start point and an end point of a vertical component of the shadow corresponding the vertical component of the object. Also the crossed angle extractor 251 may calculate the second representative segment using the linear function using the coordinates of the start point and the end point of the vertical component of the shadow.

The crossed angle extractor 251 may calculate the crossed angle between the first representative segment and the second representative segment, that is, the crossed angle between the object and the shadow of the object, and transmit the calculated crossed angle to the shooting direction calculator 255. For example, the crossed angle extractor 251 may calculate the crossed angle between the first representative segment and the second representative segment based on a point connecting the first representative segment and the second representative segment.

The reference angle calculator 253 may acquire a reference angle, which may be a second element for detecting a shooting direction of the shooting apparatus 100, based on a time and a position at which the image is captured and transmit the reference angle to the shooting direction calculator 255.

The reference angle calculator 253 may determine, to be the reference angle, a crossed angle corresponding to the time and the position at which the image is captured among stored crossed angles.

The reference angle calculator 253 may search the stored crossed angles for the crossed angle corresponding to the time and the position at which the image is captured.

The reference angle calculator 253 may determine the found crossed angle to be the reference angle.

The stored crossed angles may be previously measured or calculated through an experiment to be stored in a database (not shown). The stored crossed angles may include crossed angles between a predetermined object and a shadow of the predetermined object measured or calculated for each time and for each position based on azimuth and meridian altitude of the sun using a time and a position as variables. The crossed angles between the predetermined object and the shadow of the predetermined object obtained for each time and for each position may be crossed angles calculated for each time and for each position by analyzing an image including the predetermined object and the shadow of the predetermined object using a predetermined shooting apparatus (not shown). The predetermined shooting apparatus (not shown) may capture the predetermined object spaced apart by a preset distance at a preset height and generate an image including a cross angle between a vertical component of the predetermined object and a shadow formed by the vertical component. In this example, the preset height and the preset distance may be an average installation height and an average shooting distance of the predetermined shooting apparatus (not shown).

The reference angle calculator 253 may calculate, through an interpolation, a crossed angle approximate to the time and the position at which the image is captured among the stored crossed angles and determine the calculated crossed angle to be the reference angle.

The reference angle calculator 253 may select the crossed angle approximate to the time and the position at which the image is captured from the stored crossed angles.

For example, when an image was taken at 12:30 p.m. and crossed angles obtained for each time are 345° at 11 a.m., 355 degrees (°) at 12 p.m., and 5° at 1 p.m., the reference angle calculator 253 may select the cross angles of 12 p.m. and 1 p.m. which are close to the time of 12:30 p.m.

The reference angle calculator 253 may calculate an average angle of the selected crossed angles and determine the average angle to be the reference angle.

When the selected crossed angles are the cross angles of 12 p.m. and 1 p.m., the reference angle calculator 253 may determine 360°, that is, an average angle of the cross angles of 355° and 5° corresponding to 12 p.m. and 1 p.m. to be the reference angle.

The reference angle calculator 253 may calculate a real-time crossed angle corresponding to the time and the position at which the image is captured and determine the real-time crossed angle to be the reference angle.

For example, the reference angle calculator 253 may calculate the crossed angle corresponding to the time and the position at which the image is captured in real time based on an ecliptic coordination, an equatorial coordination, and a horizontal coordination.

The reference angle calculator 253 may calculate a position of the sun corresponding to the time and the position at which the image is captured based on an ecliptic longitude and an ecliptic latitude of the ecliptic coordination. In this example, since the ecliptic latitude is approximate to zero, the reference angle calculator 253 may calculate the position of the sun using the ecliptic longitude. The position of the sun may be a position based on the azimuth and meridian altitude of the sun, and may be a point on the ecliptic obtained for each time.

The ecliptic longitude may be expressed as shown in Equation 1.

el=L+1.915° sin g+0.020° sin 2g [Equation 1]

In Equation 1, L denotes a mean longitude.

L may be expressed as shown in Equation 2.

L=280.460°+0.9856474°n [Equation 2]

In Equation 2, n denotes a number of days elapsed since a reference date, for example, a Julian day. The Julian day may be January 1, 4713 before Christ (B.C.).

N may be expressed as shown in Equation 3.

n=JD−24511545.0 [Equation 3]

In Equation 3, JD denotes a time and a date elapsed since the Julian day of a particular time.

The reference angle calculator 253 may convert a position of the sun calculated in the ecliptic coordination into the equatorial coordination. For example, the reference angle calculator 253 may convert the ecliptic coordination into the earth-centered equatorial coordination by applying an earth rotation axis to the ecliptic coordination.

The position of the sun converted into the equatorial coordination may include a right ascension and a declination.

The right ascension may be expressed as shown in Equation 4.

Right ascension=arctan(cos e*tan el) [Equation 4]

In Equation 4, e denotes an inclination of the earth rotation axis and el denotes the ecliptic longitude.

The declination may be expressed as shown in Equation 5.

Declination=arcsin(sin e*sin el) [Equation 5]

The reference angle calculator 253 may convert the position of the sun from the equatorial coordination into the horizontal coordination. The position of the sun converted into the horizontal coordination may include an azimuth and an altitude based on a location of an observer.

The azimuth may be expressed as shown in Equation 6.

tan A=sin H/(cos H*sin Current position latitude−tan Declination*cos Current position latitude [Equation 6]

In Equation 6, A denotes the azimuth and H denotes a local hour angle. The local time angle may be calculated using the right ascension, a current position longitude, and a measurement time.

The reference angle calculator 253 may calculate a crossed angle corresponding to a time and a position at which an image is captured, for example, the azimuth of the sun in real time using a latitude and a longitude of the sun corresponding to the time and the position.

As described above, the reference angle calculator 253 may calculate the crossed angle corresponding to the time and the position at which the image is captured using Equations 1 through 6. However, embodiments are not limited thereto. For example, the reference angle calculator 253 may calculate a stored crossed angle using Equations 1 through 6.

The shooting direction calculator 255 may detect the shooting direction of the shooting apparatus 100 using the crossed angle which is a first element for detecting the shooting direction of the shooting apparatus 100 and the reference angle which is a second element for detecting the shooting direction of the shooting apparatus 100, and transmit the detected shooting direction of the shooting apparatus 100 to the shooting direction manager 257.

The shooting direction calculator 255 may calculate an angle of difference between the crossed angle and the reference angle.

When the crossed angle is 270° and the reference angle is 90°, the shooting direction calculator 255 may calculate the angle of difference to be −180°.

The angle of difference may be expressed as shown in Equation 7.

Angle of difference=Reference angle−Crossed angle [Equation 7]

The shooting direction calculator 255 may detect the shooting direction of the shooting apparatus 100 by analyzing the angle of difference based on a reference direction corresponding to the reference angle. The shooting direction of the shooting apparatus 100 may be a direction in which the shooting apparatus 100 captures the object and a shadow of the object, for example, an installation position of the shooting apparatus 100.

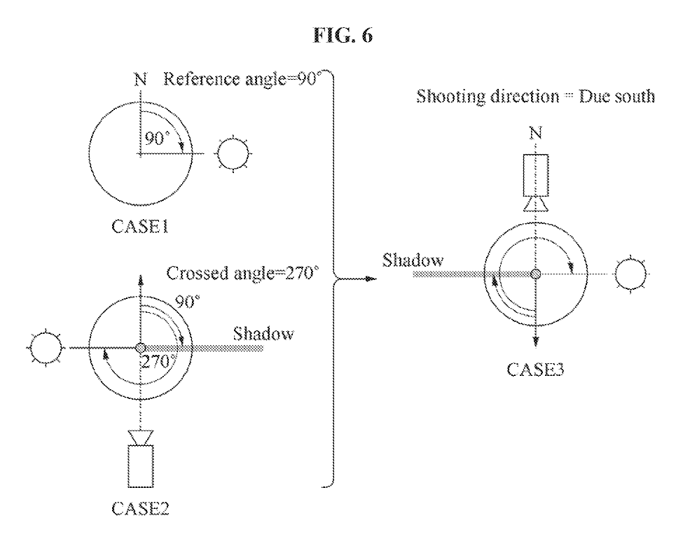

When the reference direction is the due north direction, the crossed angle is 270°, and the reference angle is 90°, the shooting direction calculator 255 may analyze the angle of difference corresponding to −180° based on the due south direction and detect the due south direction as the shooting direction of the shooting apparatus 100. Related description will be provided with reference to FIG. 6. The shooting direction manager 257 may manage the shooting direction of the shooting apparatus 100 and provide information associated with the shooting apparatus 100.

The shooting direction manager 257 may store the shooting direction of the shooting apparatus 100 in a database (not shown) by matching the shooting direction with an identifier of the shooting apparatus 100. The shooting direction of the shooting apparatus 100 may be newly stored or may be stored by updating an existing shooting direction.

The shooting direction manager 257 may provide the information associated with the shooting apparatus 100 in response to a user request.

When the user request is an image corresponding to a predetermined shooting direction, the shooting direction manager 257 may selectively search for the shooting to apparatus 100 matching the predetermined shooting direction. The shooting direction manager 257 may provide information, for example, an image associated with the shooting apparatus 100 matching the predetermined shooting direction to a user device (not shown) used by a user.

As described above, the shooting direction manager 257 may be implemented in the shooting direction analyzer 250, but is not limited thereto. For example, the shooting direction manager 257 may be integrally embodied with the manager 230.

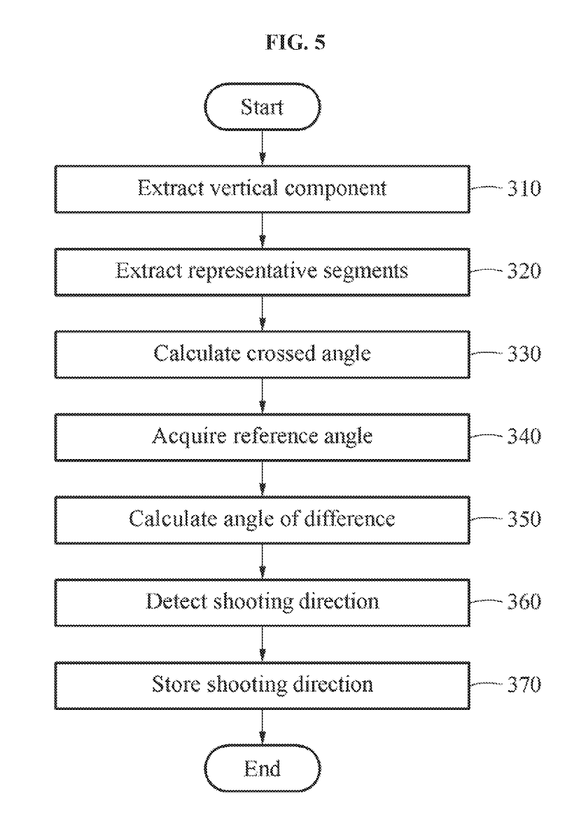

FIG. 5 is a flowchart illustrating an operation of the shooting direction detecting apparatus 200 of FIG. 1.

Referring to FIG. 5, in operation 310, the crossed angle extractor 251 may extract a vertical component of an object and a shadow formed by the vertical component from an image.

In operation 320, the crossed angle extractor 251 may extract a first representative segment that represents the vertical component and a second representative segment that represents the shadow.

In operation 330, the crossed angle extractor 251 may calculate a crossed angle between the first representative segment and the second representative segment.

In operation 340, the reference angle calculator 253 may acquire a reference angle based on a time and a position at which the image is captured.

In operation 350, the shooting direction calculator 255 may calculate an angle of difference between the crossed angle and the reference angle.

In operation 360, the shooting direction calculator 255 may detect a shooting direction of the shooting apparatus 100 by analyzing the angle of difference based on a reference direction corresponding to the reference angle.

In operation 370, the shooting direction manager 257 may store the shooting direction of the shooting apparatus 100 by matching the shooting direction with an identifier of the shooting apparatus 100.

FIG. 6 is a diagram illustrating a method of detecting a shooting direction using a reference angle and a crossed angle according to an example embodiment.

Referring to FIG. 6, when a reference direction is the due north direction, a crossed angle is 270°, and a reference angle is 90°, the shooting direction calculator 255 may analyze an angle of difference corresponding to −180° based on the due south direction and detect the due south direction as a shooting direction of the shooting apparatus 100. When CASE 2 is rotated by the angle of difference corresponding to 180° as calculated using Equation 7, a position of the sun may coincide with CASE 1 as shown by CASE 3 and a camera shooting in the due south direction may be detected.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular, however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs. DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of detecting a shooting direction, the method comprising:
calculating a crossed angle between an object and a shadow of the object in an image; and
detecting a shooting direction of a shooting apparatus used for capturing the image based on the crossed angle and a reference angle corresponding to a time and a position at which the image is captured.

2. The method of claim 1, wherein the crossed angle is a crossed angle between a vertical component of the object and a shadow formed by the vertical component.

3. The method of claim 1, wherein the position is one of an installation position of the shooting apparatus and an approximate position of the installation position, and
the time is a time and a date at which the image including the object is captured.

4. The method of claim 1, wherein the calculating comprises:
extracting, from the image, a vertical component of the object and a shadow formed by the vertical component; and
extracting a first representative segment that represents the vertical component and a second representative segment that represents the shadow and calculating a crossed angle between the first representative segment and the second representative segment.

5. The method of claim 1, further comprising:
acquiring the reference angle based on the time and the position at which the image is captured.

6. The method of claim 5, wherein the acquiring comprises:
determining a crossed angle corresponding to the time and the position at which the image is captured to be the reference angle from stored crossed angles.

7. The method of claim 6, wherein the stored crossed angles include crossed angles between a predetermined object and a shadow of the predetermined object calculated based on azimuth and meridian altitude of a sun for each time and for each position.

8. The method of claim 6, wherein the determining comprises:
calculating, through an interpolation, a crossed angle approximate to the time and the position at which the image is captured among the stored crossed angles and determining the calculated crossed angle to be the reference angle.

9. The method of claim 1, wherein the detecting comprises:
calculating an angle of difference between the crossed angle and the reference angle; and
detecting the shooting direction of the shooting apparatus by analyzing the angle of difference based on a reference direction corresponding to the reference angle.

10. The method of claim 1, further comprising:
storing the shooting direction of the shooting apparatus by matching the shooting direction with an identifier of the shooting apparatus,
wherein the identifier is an identification (ID) that represents the shooting apparatus such that the shooting apparatus is able to be identified.

11. A shooting direction detecting apparatus comprising:
a collector configured to acquire an image from a shooting apparatus used for capturing the image; and
a shooting direction analyzer configured to calculate a crossed angle between an object and a shadow of the object in the image and detect a shooting direction of the shooting apparatus used for capturing the image based on the crossed angle and a reference angle corresponding to a time and a position at which the image is captured.

12. The shooting direction detecting apparatus of claim 11, wherein the crossed angle is a crossed angle between a vertical component of the object and a shadow formed by the vertical component.

13. The shooting direction detecting apparatus of claim 11, wherein the position is one of an installation position of the shooting apparatus and an approximate position of the installation position, and
the time is a time and a date at which the image including the object is captured.

14. The shooting direction detecting apparatus of claim 11, wherein the shooting direction analyzer is configured to extract, from the image, a vertical component of the object and a shadow formed by the vertical component, extract a first representative segment that represents the vertical component and a second representative segment that represents the shadow, and calculate a crossed angle between the first representative segment and the second representative segment.

15. The shooting direction detecting apparatus of claim 11, wherein the shooting direction analyzer comprises:
a reference angle calculator configured to acquire the reference angle based on the time and the position at which the image is captured.

16. The shooting direction detecting apparatus of claim 15, wherein the reference angle calculator is configured to determine a crossed angle corresponding to the time and the position at which the image is captured to be the reference angle from stored crossed angles.

17. The shooting direction detecting apparatus of claim 16, wherein the stored crossed angles include crossed angles between a predetermined object and a shadow of the predetermined object calculated based on azimuth and meridian altitude of a sun for each time and for each position.

18. The shooting direction detecting apparatus of claim 16, wherein the reference angle calculator is configured to calculate, through an interpolation, a crossed angle approximate to the time and the position at which the image is captured among the stored crossed angles and determine the calculated crossed angle to be the reference angle.

19. The shooting direction detecting apparatus of claim 11, wherein the shooting direction analyzer comprises:
a shooting direction calculator configured to calculate an angle of difference between the crossed angle and the reference angle and detect the shooting direction of the shooting apparatus by analyzing the angle of difference based on a reference direction corresponding to the reference angle.

20. The shooting direction detecting apparatus of claim 11, wherein the shooting direction analyzer comprises:
a shooting direction manager configured to store the shooting direction of the shooting apparatus by matching the shooting direction with an identifier of the shooting apparatus,
wherein the identifier is an identification (ID) that represents the shooting apparatus such that the shooting apparatus is able to be identified.
